(19) United States
(12) Patent Application Publication
(10) Pub. No.: US 2013/0133256 A1
(43) Pub. Date: May 30, 2013

(54) AIR INTRODUCING CONTORL DEVICE FOR PLANT POT

(71) Applicant: CHIN-TAI TSAI, Taichung City (TW)

(72) Inventor: CHIN-TAI TSAI, Taichung City (TW)

(21) Appl. No.: 13/680,082

(22) Filed: Nov. 18, 2012

(30) Foreign Application Priority Data
Nov. 30, 2011 (TW) 100144057

(51) Int. Cl. A01G 9/02; A01G 27/00

(52) U.S. Cl. 47/79; 47/65.5

(57) ABSTRACT

A plant pot includes a pot having an enclosed space and a room defined therein. The room receives soil therein. At least one passage communicates with the room and the enclosed space. A tube is connected to the pot and has a path defined axially therethrough, the path respectively communicates with interior and exterior of the enclosed space. A resistance member is located in one end of the tube and has multiple micro paths which communicate with the interior of the enclosed space. A resistance is formed when exterior air passes through the tube and the resistance member so as to control speed and volume of the exterior air into the enclosed space.

### FIELD OF THE INVENTION

The present invention relates to a plant pot, and more particularly, to an air introducing control device for a plant pot.

### BACKGROUND OF THE INVENTION

The conventional plant pot is disclosed in U.S. Pat. No. 4,344,251 and generally comprises a pot and a separation board 36 defines the interior of the pot into an upper space and a bottom space, wherein the plant and soil are located in the upper space, and liquid is filled in the bottom space. By using a absorbing member, the liquid is sucked and delivered to the soil. Two pipes are inserted into the bottom space so as to provide air to the liquid in the bottom space.

U.S. Pat. No. 4,356,665 discloses a room communicates with the bottom space of the plant pot. U.S. Pat. No. 4,962,615 discloses a pipe is inserted into the bottom space so as to provide air to the liquid.

The present invention intends to provide a plant pot which controls the speed and volume that the exterior air is introduced into the space of the pot.

### SUMMARY OF THE INVENTION

The present invention relates to a plant pot and comprises a pot having an enclosed space and a room defined therein. The room receives soil therein. At least one passage communicates with the room and the enclosed space. A tube is connected to the pot and has a path defined axially therethrough, the path respectively communicates with interior and exterior of the enclosed space. A resistance member is located in one end of the tube and has multiple micro paths which communicate with the interior of the enclosed space. A resistance is formed when exterior air passes through the tube and the resistance member so as to control speed and volume of the exterior air into the enclosed space.

The primary object of the present invention is to provide an air introducing control device for a plant pot so as to control the speed and volume of the exterior air into the enclosed space, such that the liquid in the enclosed space of the pot is controlled to be supplied to the soil.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the air introducing control device of a plant pot of the present invention;

FIG. 2 is a perspective view to show the plant pot with air introducing control device of the present invention;

FIG. 3 is a cross sectional view of the plant pot with air introducing control device of the present invention, and

FIG. 4 shows different embodiments of the resistance member of the present invention.

### DETAILED DESCRIPTION OF THE PREFERRED EMBODIMENT

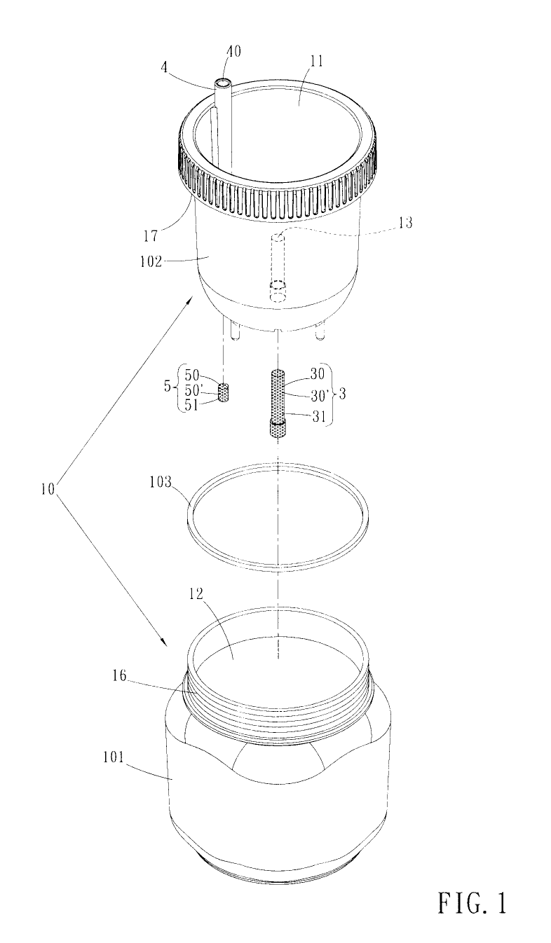

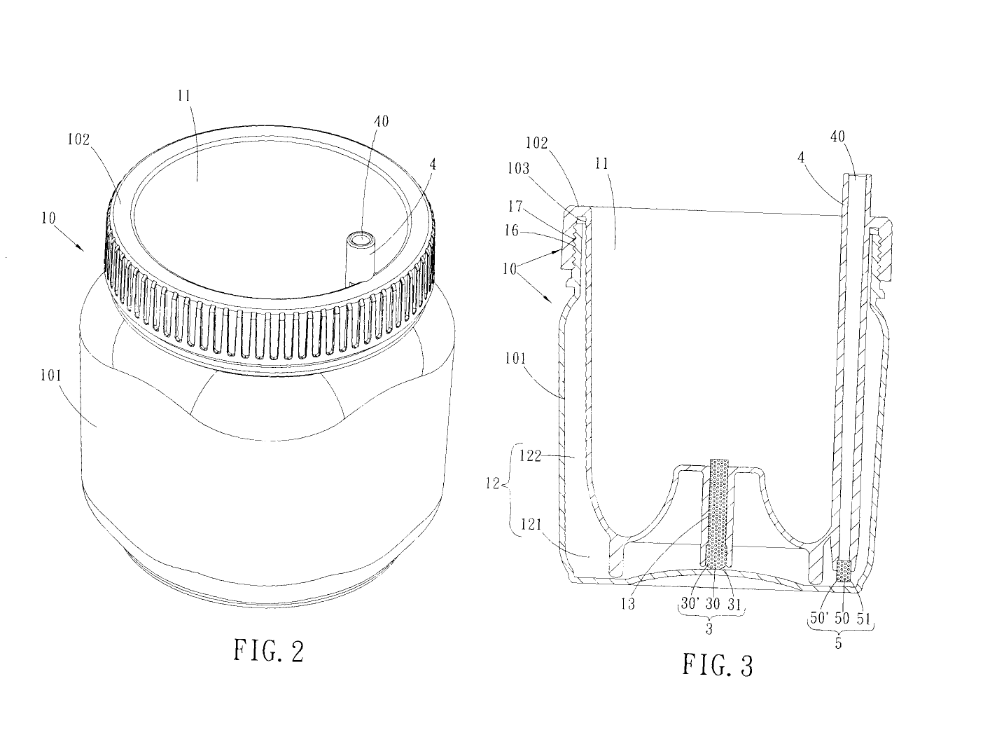

Referring to FIGS. 1 to 4, the plant pot of the present invention comprises a pot 10 having an enclosed space 12 and a room 11 defined therein. The room 11 receives soil therein so that the plant is planted to the soil. At least one passage 13 communicates with the room 11 and the enclosed space 12. The pot 10 is composed of a first body 101 and a second body 102. The first body 101 has the enclosed space 12 and a first connection portion 16 is formed on the outer periphery of the opening of the first body 101. The second body 102 has the recessed room 11 and the t least one passage 13 is defined in the inner end of the room 11. The second body 102 has a second connection portion 17 which is connected to the first connection portion 16. A sealing member 103 is located between the first and second bodies 101, 102 to form the enclosed space 12. The enclosed space 12 has a bottom space 12 and a peripheral space 122. The seeping member 3 is located in the at least one passage 13. The second connection portion 17 is connected to the first connection portion 16 by threaded engagement, snapping or rotatable engagement. Preferably, the first body 101 is semi-transparent or transparent. The first and second bodies 101, 102 are made by way of blow molding.

The seeping member 3 includes multiple micro paths 31, and two ends of the seeping member 3 communicate with the room 11 and the enclosed space 12 respectively. The liquid in the enclosed space 12 can be provided to the soil via the micro paths 31. The seeping member 3 is composed of multiple particles 30, 30′ such as copper particles which are made by way of sintering. The liquid moves from the lower end toward the upper end via the micro paths 31 by the surface tension of the liquid.

The tube 4 is connected to the pot 10 and has a path 40 defined axially therethrough. Two ends of the path 40 respectively communicate with interior and exterior of the enclosed space 12. A resistance member 5 is located in one end of the tube 4. The tube 4 and the pot 10 can be made integrally by way of blow molding or injection molding, or the tube 4 and the pot 10 can be two individual parts.

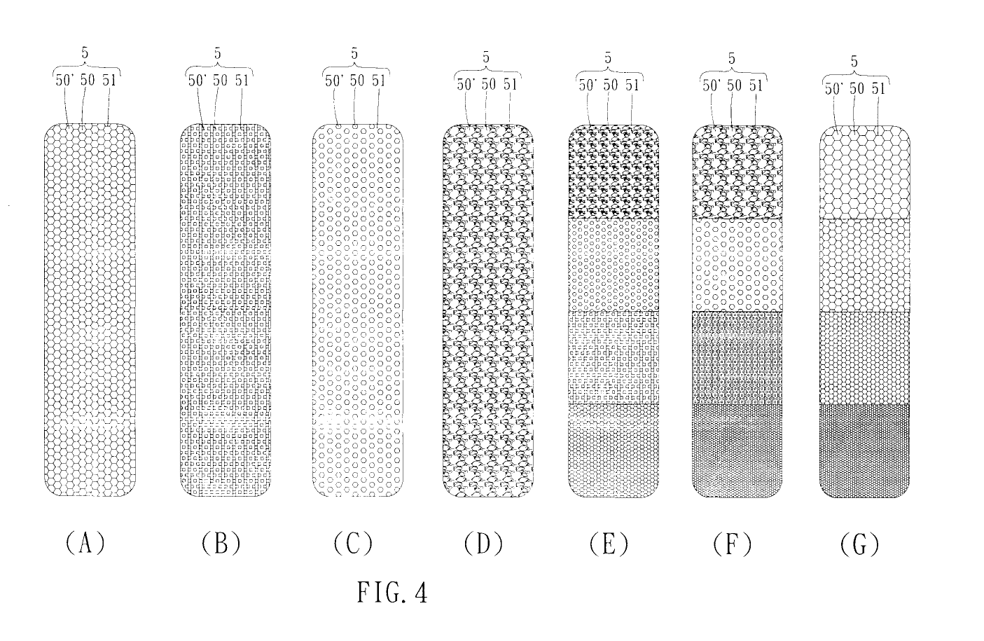

The resistance member 5 is an air permeable part such as ceramic part, and has multiple micro paths 51 which communicate with the interior of the enclosed space 12. The micro paths 51 are formed by notches defied in the resistance member 5, or the micro paths 51 of the resistance member 5 are formed by gaps between multiple particles 50, 50′. A resistance is formed when exterior air passes through the tube 4 and the resistance member 5 so as to control speed and volume of the exterior air into the enclosed space 12. The resistance member 5 is formed by the multiple particles 50, 50′ of the same material and size such as the embodiments A-D shown in FIG. 4. The resistance member 5 can also be formed by the multiple particles 50, 50′ of different materials and the same size such as the embodiment E in FIG. 4. The resistance member 5 may also be formed by the multiple particles 50, 50′ of the same material and different sizes, the multiple particles 50, 50′ of the resistance member 5 are arranged to have increased density such as the embodiment G in FIG. 4. The multiple particles 50, 50′ of the different material and different sizes can be arranged to have increased density such as the embodiment F in FIG. 4. The resistance member 5 is connected to the tube 4 by way of threadedly connecting, mounting to each other or snapping to each other.

When in use, the liquid is filled in the enclosed space 12 of the first body 101 and the resistance member 5 such as the embodiment C in FIG. 4, is connected to the end of the tube 4 of the second body 102. One end of the resistance member 5 protrudes beyond the end of the tube 4. The sealing member 103 is then connected between the first and second bodies 101, 102. The first connection portion 16 of the first body 101 is threadedly connected to the second connection portion 17 of the second body 102 so that the sealing member 103 is well position to form the enclosed space 12. The liquid in the enclosed space 12 is pushed to flow from the bottom space 121 to the peripheral space 122. The seeping member 3 is inserted into the passage 13 and protrudes into the enclosed space 12. The soil is put in the room 11 and covers the seeping member 3. The liquid in the enclosed space 12 moves upward to the soil by the liquid surface tension. The liquid fills the micro paths 31, 51 of the seeping member 3 and the resistance member 5. The soil contacts the seeping member 3 so that the liquid is sucked by the soil. The pressure in the enclosed space 12 gradually reduces and eventually is a negative pressure. Under this condition, because the size of the micro paths 51 or the particles in the resistance member 5 is larger than the size of the micro paths 31 or the particles in the seeping member 3 (the density of the micro paths 51 is less than that of the micro paths 31, or the micro paths 51 is located higher than the micro paths 31), so that the air resistance for the liquid flowing from the path 40 of the tube 4 and the micro paths 51 of the resistance member 5 into the enclosed space 12 is less than that for the liquid flowing from the soil to the micro paths 31 of the seeping member 3 into the enclosed space 12. The exterior air is passively sucked into the peripheral space 122 of the enclosed space 12 via the path 40 of the tube 4 and the micro paths 51 of the resistance member 5 because of the negative pressure in the enclosed space 12. Therefore, the pressure of the peripheral space 122 gradually increases to one atmospheric pressure, so that the pressure balance is reached and the seepage rate of the liquid is fixed. Therefore, the speed and volume of the air supplied to the enclosed space 12 via the micro paths 51 is controlled accordingly, and the amount of the liquid in the enclosed space 12 supplied into the soil via the seeping member 3 is controlled.

When the plant does not require too much water, the mediate size particles 50, 50′ are replaced by larger or smaller size particles 50, 50′ such as the particles shown by embodiments A, B, D and E in FIG. 4, to form a new resistance member 5. By the change of the size of the micro paths 51, the speed and volume of the air passing through the micro paths 51 and the passage 40 are changed. Before replacing the particles, the liquid in the enclosed space 12 was controlled to pass through the micro paths 31 of the seeping member 3 by different speeds, in other words, the central area has more liquid than the peripheral area. After the new particles are used, the area that the liquid is sucked to the soil is changed and this is suitable for the plant that does not require too much water.

Alternatively, the mediate size particles 50, 50′ are replaced by the particles 50, 50′ with the same or different material and different size so as to have the resistance member 5 with increased density such as the embodiments G and F in FIG. 4. The resistance member 5 is inserted into the path 40 of the tube 4 by different depths to control the speed and volume that the liquid in the enclosed space 12 passes through the path 40 and the micro paths 51. By this way, the liquid in the enclosed space 12 passes through the micro paths 31 and enter the soil is controlled. The central area has more liquid than the peripheral area so that the mode of supplying liquid is suitable for the plant requiring less water. The user can reduce the times of watering the plant and meets different needs of different plants and users.

While we have shown and described the embodiment in accordance with the present invention, it should be clear to those skilled in the art that further embodiments may be made without departing from the scope of the present invention.

What is claimed is:

1. A plant pot comprising:
a pot having an enclosed space and a room defined therein, the room adapted to receive soil therein, at least one passage communicating with the room and the enclosed space;
a tube connected to the pot and having a path defined axially therethrough, two ends of the path respectively communicating with interior and exterior of the enclosed space, a resistance member located in one end of the tube, and
the resistance member having multiple micro paths and communicating with the interior of the enclosed space, a resistance being formed when exterior air passes through the tube and the resistance member so as to control speed and volume of the exterior air into the enclosed space.

2. The pot as claimed in claim 1, wherein the micro paths are formed by notches defied in the resistance member.

3. The pot as claimed in claim 1, wherein the micro paths of the resistance member are formed by gaps between multiple particles.

4. The pot as claimed in claim 3, wherein the resistance member is formed by the multiple particles of the same material and size.

5. The pot as claimed in claim 3, wherein the resistance member is formed by the multiple particles of different materials and the same size.

6. The pot as claimed in claim 3, wherein the resistance member is formed by the multiple particles of the same material and different sizes.

7. The pot as claimed in claim 6, wherein the multiple particles of the resistance member are arranged to have increased density.

8. The pot as claimed in claim 3, wherein the resistance member is formed by the multiple particles of different material and different sizes.

9. The pot as claimed in claim 8, wherein the multiple particles of the resistance member are arranged to have increased density.

10. The pot as claimed in claim 3, wherein the resistance member is formed by the multiple copper particles which are made by way of sintering.

11. The pot as claimed in claim 2, wherein the resistance member is connected to the tube by way of threadedly connecting, mounting to each other or snapping to each other.

12. The pot as claimed in claim 11, wherein the at least one passage receives a seeping member therein, the seeping member includes multiple micro paths, the seeping member communicates between the room and the enclosed space.

13. The pot as claimed in claim 4, wherein the resistance member is connected to the tube by way of threadedly connecting, mounting to each other or snapping to each other.

14. The pot as claimed in claim 13, wherein the at least one passage receives a seeping member therein, the seeping member includes multiple micro paths, the seeping member communicates between the room and the enclosed space.

15. The pot as claimed in claim 5, wherein the resistance member is connected to the tube by way of threadedly connecting, mounting to each other or snapping to each other.

16. The pot as claimed in claim 15, wherein the at least one passage receives a seeping member therein, the seeping member includes multiple micro paths, the seeping member communicates between the room and the enclosed space.

17. The pot as claimed in claim 7, wherein the resistance member is connected to the tube by way of threadedly connecting, mounting to each other or snapping to each other.

18. The pot as claimed in claim 17, wherein the at least one passage receives a seeping member therein, the seeping member includes multiple micro paths, the seeping member communicates between the room and the enclosed space.

19. The pot as claimed in claim 9, wherein the resistance member is connected to the tube by way of threadedly connecting, mounting to each other or snapping to each other.

20. The pot as claimed in claim 19, wherein the at least one passage receives a seeping member therein, the seeping member includes multiple micro paths, the seeping member communicates between the room and the enclosed space.
